(19) United States
(12) Patent Application Publication
(10) Pub. No.: US 2006/0247909 A1
(43) Pub. Date: Nov. 2, 2006

(54) System and method for emulating a logic circuit design using programmable logic devices

(76) Inventors: Madhav P. Desai, Mumbai (IN); Mitra Sudhir Purandare, Mumbai (IN); Himanshu Sharma, Delhi (IN); Sachin B. Patkar, Mumbai (IN)

Correspondence Address: PERKINS COIE LLP, P.O. BOX 2168, MENLO PARK, CA, 94026, US

(21) Appl. No.: 11/207,559

(22) Filed: Aug. 18, 2005

(30) Foreign Application Priority Data
Apr. 27, 2005 (IN) 211/MUM/05

(51) Int. Cl. G06F 17/50; G06F 9/455; G06F 9/45

(52) U.S. Cl. 703/23; 716/7

(57) ABSTRACT

The present system provides a number of hardware and software modules that emulate logic circuit designs for simulation purposes. The present system receives an initial logic circuit design and provides algorithms to recode, weight partition and interconnect an emulated logic circuit wherein the features of the original circuit design are preserved. The system further provides a monitoring of the internal signals within the emulated circuit.

### TECHNICAL FIELD

The present invention relates to the field of electronic design automation and more particularly it relates to a system and methods for emulating a logic circuit design. Furthermore, the present invention pertains to emulation of any design or algorithm through hardware.

### BACKGROUND OF THE INVENTION

With the rapid progress in process technology; designers are integrating more functionality onto the same silicon die. However, the large size and complexity of these designs makes functional verification a very difficult task and hence the design cannot be thoroughly tested. If functional bugs are not found prior to fabrication, they will cause design re-spins which are both expensive and time consuming to the manufacturer of the silicon die.

As a result, several technologies have evolved to address the problem of functional verification. Some traditional simulation techniques fall short in terms of speed for today's Application Specific Integrated Circuits (ASICs). On the other extreme is a prototyping solution which is not flexible. Hardware verification tools using emulation are fast as well as flexible compared to software simulation tools. These types of emulation systems are built using commercial Field Programmable Gate Arrays (FPGAs).

FPGA based logic emulators are capable of emulating complex logic designs at clock speeds faster than an accelerated software simulator. The architecture of the emulation board has a major impact on the performance, efficiency, scalability, cost and flexibility of the emulation system. The system accepts a design in Register Transfer Level form (RTL) and maps it into the emulation hardware. Earlier the systems were single FPGA based non-piped systems, which have now evolved to a multi-FPGA piped system with distributed control.

In these prior systems, circuit-switching techniques are used to provide output signals from one chip to another chip. Other prior art systems do not partition the design for efficient utilization and hence do not allow for signal visibility. Also in these prior art solutions, the memory component on an FPGA is used, thereby degrading the efficiency of the overall process.

### SUMMARY OF THE INVENTION

In order to provide an adequate emulation system, one embodiment of the present invention provides a computing system including a long term memory, a processor readable memory and a processor, in communication with one another, a long term memory including a recoding module, the recoding module in communication with a processor and the processor readable memory. This embodiment further comprises a recoding module that replaces a plurality of bi-directional ports connecting a plurality of the components in the logic circuit design with a plurality of unidirectional ports; a partitioning module for partitioning the logic circuit design into a plurality of independent logic circuit designs; a memory extractor and mapper module for performing memory transformations by extracting a plurality of components of the independent logic circuit design wherein each of the plurality of components comprises of a memory component and a logic component, and mapping the memory component onto an external system memory; a monitoring module for observing the visibility of internal signal buried in the logic circuit design, on the plurality of programmable logic device; and a time division multiplexing module for scheduling the nets.

Other embodiments of the present invention include a method of creating the recoded logic circuit comprising the steps of recoding the logic circuit design; assigning a first weight to each of one or more components to give a list of first weights, wherein each of the components comprises a memory component and a logic component; assigning a second weight to each of one or more ports, the ports interconnecting the components, wherein the second weight is equal to a number of wires, wherein the wires interconnect the components; generating a tree structure using the list of first weights; and partitioning the tree structure using a tree-partitioning algorithm into a plurality of independent logic circuit designs, such that an original connectivity of each of the components is maintained.

These and other embodiments described herein provide a solution for emulating, partitioning and testing logic circuits.

### BRIEF DESCRIPTION OF THE DRAWINGS

The accompanying figures together with the detailed description below are incorporated in and form part of the specification, serve to further illustrate various embodiments and to explain various principles and advantages all in accordance with the present invention.

FIG. 1 depicts an embodiment of the emulation system comprising a host PC and an attached emulation hardware board.

FIG. 2 is a flowchart depicting a preferred embodiment of a method for partitioning the logic circuit design.

FIG. 3 is a block diagram for interfacing the memory elements in an embodiment of the invention to an external memory.

FIG. 4 is a block diagram depicting the Time Division Multiplexing (TDM) phases and nets served in corresponding phases in an embodiment of the present invention.

FIG. 5 depicts the signals in the TDM phases as shown in FIG. 4.

FIG. 6 shows individual partitions being emulated on the corresponding FPGAs using one embodiment of the present invention.

FIG. 7 shows one embodiment of the emulation board to test the design of logic circuits.

FIG. 8 depicts an Inter-FPGA communication along with the change detect mechanism of one embodiment of the present invention.

FIG. 9 is a block diagram depicting the monitoring/observation logic used for monitoring an address bus and a data bus in one embodiment of the present invention.

FIG. 10 is a block diagram for monitoring a signal either struck at 0 or at 1 and monitoring the clock cycle till the circuit stabilizes in another embodiment of the present invention.

### DETAILED DESCRIPTION OF DRAWINGS

The present invention may be embodied in several forms and manners. The description provided below and the drawings show exemplary embodiments of the invention. Those of skill in the art will appreciate that the invention may be embodied in other forms and manners not shown below. The invention shall have the full scope of the claims and shall not be limited by the embodiments shown below. It is understood that the use of relational term, if any, such as first, second, top and bottom, front and rear and the like are used solely for distinguishing one entity or action from another, without necessarily requiring or implying any such actual relationship or order between such entities or actions.

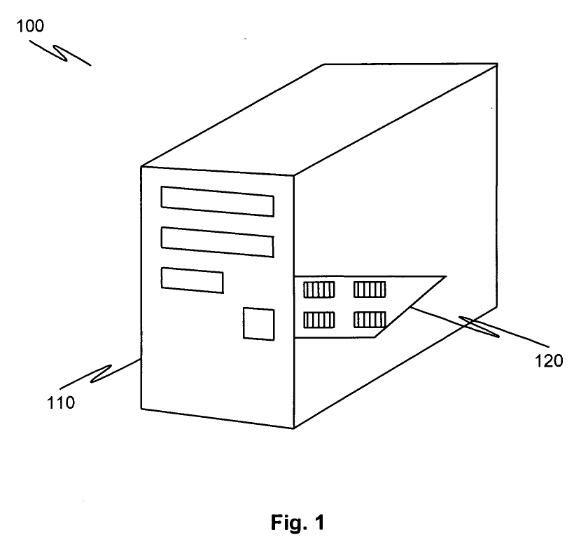

FIG. 1 shows one embodiment of an emulations system 100 that comprises a Host PC 110 and an emulation hardware board 120 attached to it. In this embodiment a set of software tools is contained on the Host PC 110 to execute the transformations on the given RTL design as described below. The Host PC 110 works in conjunction with the hardware board 120 to provide the emulation features as subsequently described.

The embodiments of the present emulation system 100 consist of hardware and a set of software tools that have been written to make the design mapable on this emulation hardware and also add extra functionality. The present system 100 accepts the design in RTL form and maps it into the emulation hardware using a number of modules. The embodiments allow full internal signal visibility just like software simulations and are scalable without much loss in performance. In this embodiment the emulation system is connected to a host PC 110 which has total control over the emulation process.

Embodiments of the emulation system may use commercial FPGAs. The board comprising of FPGAs 120 is designed to sit on a PCI slot of the host machine 110. It uses a PCI interface chip provides a high performance slave interface for PCI boards. The PCI interface chip is connected to the board controller through its local bus. The Complex Programmable Logic Device (CPLD) sits on the local bus to take care of the local bus protocol before the FPGAs are fully configured. After the configuration, the board controller starts communicating with the PCI chip over the local bus provided by the PCI interface chip. The host computer 110 directs all the actions on the board. It also acts as an interface to the user. A host PC controls 110 the emulation process by issuing commands to a board controller. In this way, the application on the host 110 can command the board controller to perform activities. The major type of commands are providing inputs, initiating an emulation cycle, setting up addresses to monitor, start monitoring and reading outputs. The input logic circuit design transformations of the present embodiments preserve the functionality of the original circuit design.

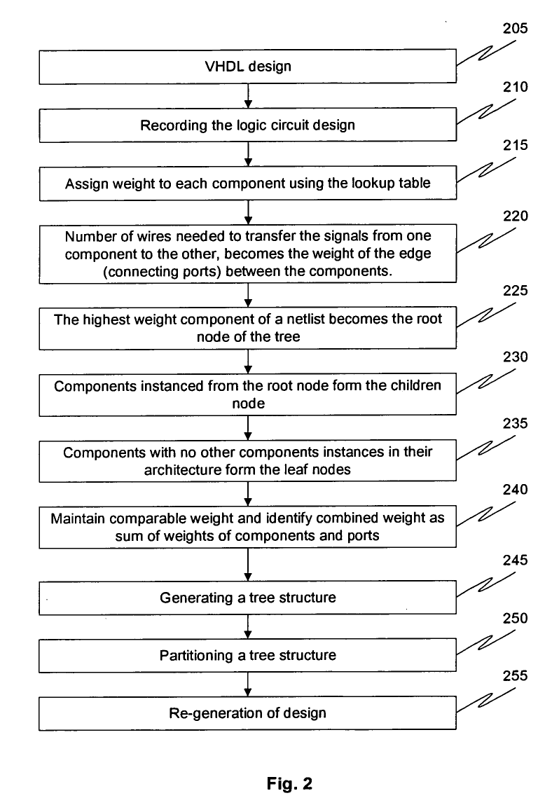

For the design to be mapped on to the emulator hardware, it has to be taken through a series of transformations. This transformations process makes changes in the RTL code to take into account the hardware architecture of the emulation system. These transformations do not change the functionality of the design in any way. All these transformations are VHDL-in-VHDL-out transformations. These transformations are realized by computer programs, that take in the RTL description of the design and give out a functional equivalent design. Numerous modules are provided in the present embodiments that combine the computer programs with the hardware as subsequently described with reference to FIGS. 2-10. The fact that these transformations are performed by the present system at the RTL level and not at the gate level is advantageous as it makes it possible to emulate the design at a very early stage in the design cycle.

The host 110 and board 120 therefore provide one embodiment of the present invention that comprises a computing system that includes a long term memory, a processor readable memory and a processor, in communication with one another, a long term memory including a recoding module, the recoding module in communication with a processor and the processor readable memory. The host 110 and board 120 further provide a recoding module that replaces a plurality of bi-directional ports connecting a plurality of the components in the logic circuit design with a plurality of unidirectional ports; a partitioning module for partitioning the logic circuit design into a plurality of independent logic circuit designs; a memory extractor and mapper module for performing memory transformations by extracting a plurality of components of the independent logic circuit design wherein each of the plurality of components comprises of a memory component and a logic component, and mapping the memory component onto an external system memory; a monitoring module for observing the visibility of internal signal buried in the logic circuit design, on the plurality of programmable logic device; and a time division multiplexing module for scheduling the nets.

FIG. 2 is a flowchart 200 depicting one method for partitioning a logic circuit design that may be enacted by the system 100 as shown in FIG. 1. The method comprises generating a tree, assigning weights to the branches and partitioning the tree into groups of braches. The process of FIG. 2 therefore employs a recoding module, a tree generation module and a partitioning module.

The method 200 comprises using the VHDL design as the input to step 205 to the system where it is read and analyzed. The recoding module recodes the input logic circuit design in step 210 by replacing the bi-directional ports by unidirectional ports. After the analysis and recoding of the input logic circuit design weights are assigned to components in step 215 of the logic circuit design using a lookup table. The number of wires needed to transfer the signals from one component to the other becomes the weight of the connecting ports between the components in step 220. The highest weight component becomes the top most entity. Further a tree structure is generated by the tree generation module with the top most entity forming a root-node of the tree in step 225 and the component instances form the children node in step 230. The ports weight that is the number of wires needed to transfer the signals for each entity forms the weights of the edges between its instance and the parent to that instance. The instances of entity with no component instances in its architecture, forms the leaf nodes in the tree in step 235. The generated tree structure maintains a comparable weight and the identified combined weight as the sum of weights of components and ports in step 240. The tree is then partitioned in step 250 into two or more pieces each of which can fit into one FPGA on the board. The design is then re-generated in step 255 however the size of the design partitions increases because each transformation is adding its own logic and some wrappers to the design.

Another embodiment of a method using the system hardware would comprise the steps of: partitioning the logic circuit design into a plurality of independent logic circuit designs; performing a memory transformation on a plurality of components of the independent logic circuit designs wherein each of the plurality of components comprises of a memory component and a logic component; whereby the plurality of components are one of the plurality of programmable logic devices; performing a monitoring transformation on the independent logic circuit designs to monitor a plurality of internal signals sent and received by the logic components; and interconnecting the independent logic circuit designs using a time phase schedule for communication maintaining an original functionality of the logic circuit design.

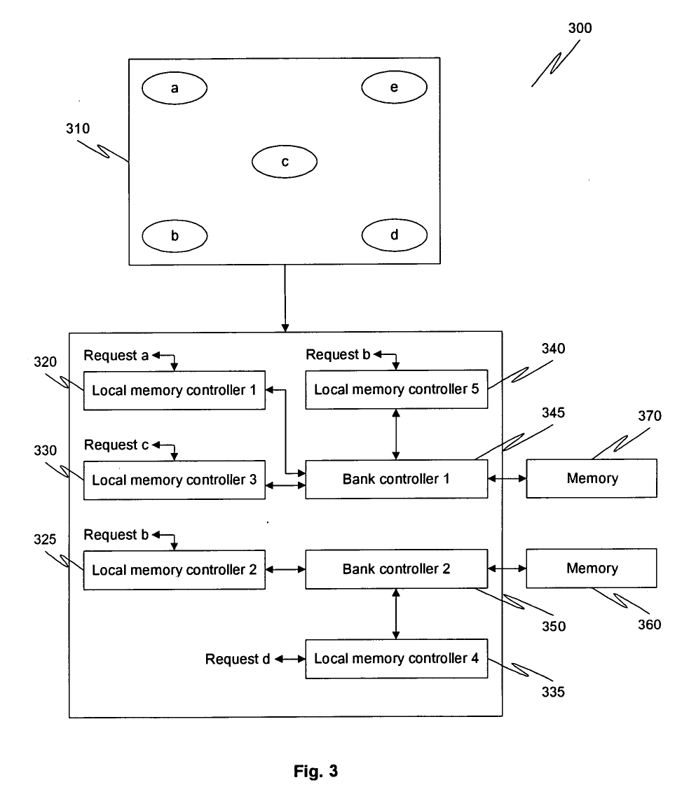

Another embodiment of the emulation system is shown in FIG. 3, which shows a block diagram 300 for an interface to memory. With increasing design complexity, the present emulation system must handle memories of various sizes and in various levels of the design. The present emulation system is able to provide such diverse memory requirements by using memory on the FPGA and which has a fixed specification. The memory transformation is executed on each of the partitions using the memory extractor and mapper module. The transformed design will have a memory controller through the block memory present on the FPGA. The block diagram 300 shows the memory elements namely a,b, c,d and e 310 in the design. These memory elements in the design namely a, b, c, d and e 310 can be transformed to external memory module 360 and 370 outside the FPGA. The local memory controllers 320, 325, 330, 335 and 340 detect all the memory requests made by the logic blocks 310 from each of the memory elements. The local memory controllers in turn then communicate with the respective bank controllers 345 and 350. Each of these bank controllers communicates with the external memory 360 and 370. The external memory 360 and 370 is partitioned into segments which are then allocated to the logic blocks requiring memory modules. This transformation will extract the memory in the design and map it into external memory. If this is not done the memory will be mapped onto the FPGA resources, resulting in a very wasteful use of the FPGA resources.

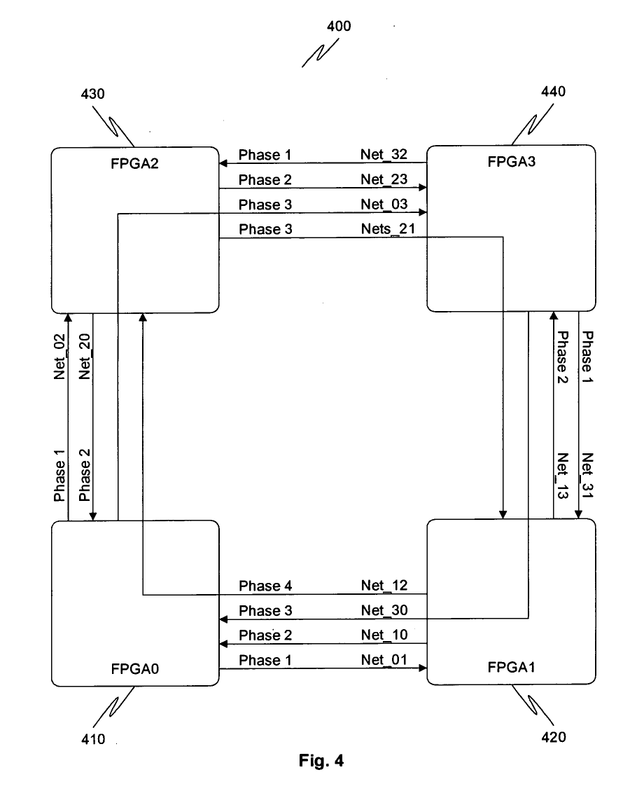

FIG. 4 is a block diagram 400 depicting the Time Division Multiplexing (TDM) phases and nets served in corresponding phases. This is provided by an embodiment of the time division multiplexing module that transforms the design so that all the inter-FPGA communication may happen on the TDM bus shared by all the FPGAs. The TDM of the bus is used to perform all the communication. It provides the abstraction where the user thinks that all the inter-FPGA nets are served by dedicated wires while actually they are time multiplexed over a fixed number of TDM wires. The TDM bus goes through a sequence of time stamps which configures the time multiplexed connections for serving a set of connections. All the issued time stamps serve all the inter-FPGA nets. As shown in FIG. 4, each of the FPGAs is configured to work in the predetermined manner using the controller logic on the board. The controller logic has the logic necessary to run the TDM phase in the circuit. Each of the FPGAs is FPGA0 410, FPGA1 420, FPGA2 430, FPGA3 440 connected as shown in the figure.

During the Phase 1, FPGA0 410 and FPGA3 440 are in transmitting mode while FPGA1 420 and FPGA2 430 are in receiving mode. In this phase FPGA0 410 sends signals simultaneously on Net_01 and Net_02, while FPGA3 440 sends signals simultaneously on Net_31 and Net_32.

During the Phase 2, FPGA0 410 and FPGA3 440 are in receiving mode while FPGA1 420 and FPGA2 430 are in transmitting mode. In this phase FPGA1 420 sends signals simultaneously on Net_10 and Net_13, while FPGA2 430 sends signals simultaneously on Net_23 and Net_20.

During the Phase 3, FPGA0 410 and FPGA3 440 are in transmitting mode while FPGA1 420 and FPGA2 430 are in relay mode. FPGA0 transmits a signal for FPGA3 440 along Net_03 where FPGA2 forward the incoming signals to FPGA3 440. Similarly FPGA3 440 transmits a signal for FPGA0 410 along Net_30 where FPGA1 forwards the incoming signals to FPGA0 410.

During the Phase 4, FPGA1 420 and FPGA2 430 are in transmitting mode while FPGA0 410 and FPGA3 440 are in relay mode. FPGA2 430 transmits a signal for FPGA1 420 along Net_21 where FPGA3 440 forwards the incoming signals to FPGA1 420. Similarly FPGA1 420 transmits a signal for FPGA2 430 along Net_12 where FPGA0 410 forwards the incoming signals to FPGA1 420.

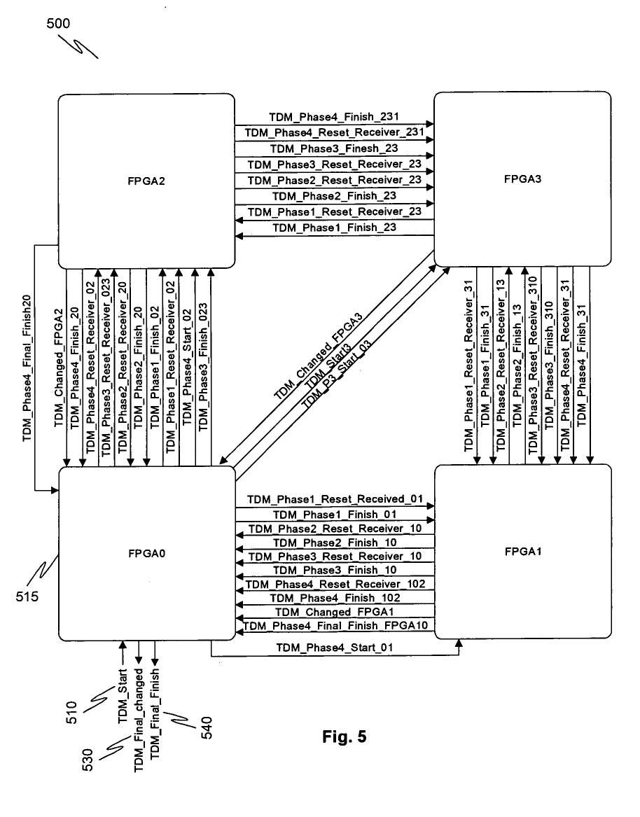

FIG. 5 depicts the signals in TDM phases 500. In this embodiment, the TDM_Start signal 510 is given to FPGA0 515, which in turn starts the TDM across the FPGAs. Each phase starts with a Reset_Receiver signal between two FPGAs and ends with a Phase_Finish signal. This cycle is initialized by Reset_Receiver signal and completed by the Phase_Finish. After the completion of the four phases as mentioned above another TDM_Changed signal is generated by each of the FPGAs and communicated to FPGA0 515 and final TDM_Final_changed 530 and TDM_Final_Finish 540 signals are generated.

Providing the connections as described above, another method provided by the present embodiments includes the steps of connecting at least two of the independent logic circuit design with a plurality of signal-communicating paths; communicating a plurality of signals between the independent logic circuit designs in a plurality of time phase schedules; and sending the plurality of signals through the signal-communicating path in the plurality of time phase schedules.

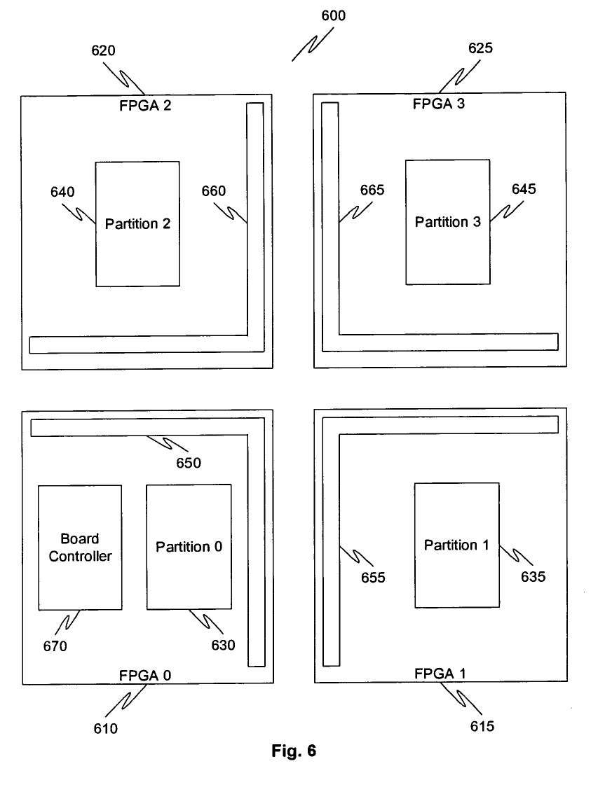

FIG. 6 shows the individual partitions being emulated on the corresponding FPGAs. With the increase in the number of FPGAs on the board, all the transformations are the same except that more partitions are generated as there are more FPGAs on the board. The transformations process changes the design and introduces a hardware wrapper around it to preserve the functionality. FIG. 6 shows four FPGAs 610, 615, 620 and 625 where each partition is being emulated as created by the partition module. The Partitions are; Partition 0 630, Partition 1 635, Partition 2 640, and Partition 3 645 as shown in the figure. The respective hardware wrappers are 650, 655, 660 and 665 as depicted in the figure. The Board controller 670 on FPGA0 610 controls all the control signals to the other FPGAs. At the end of all the transformations, the original design is changed and has some wrappers around it that are controlled by some control signals. By choosing an appropriate sequence of control signals the functionality of the design can be kept the same.

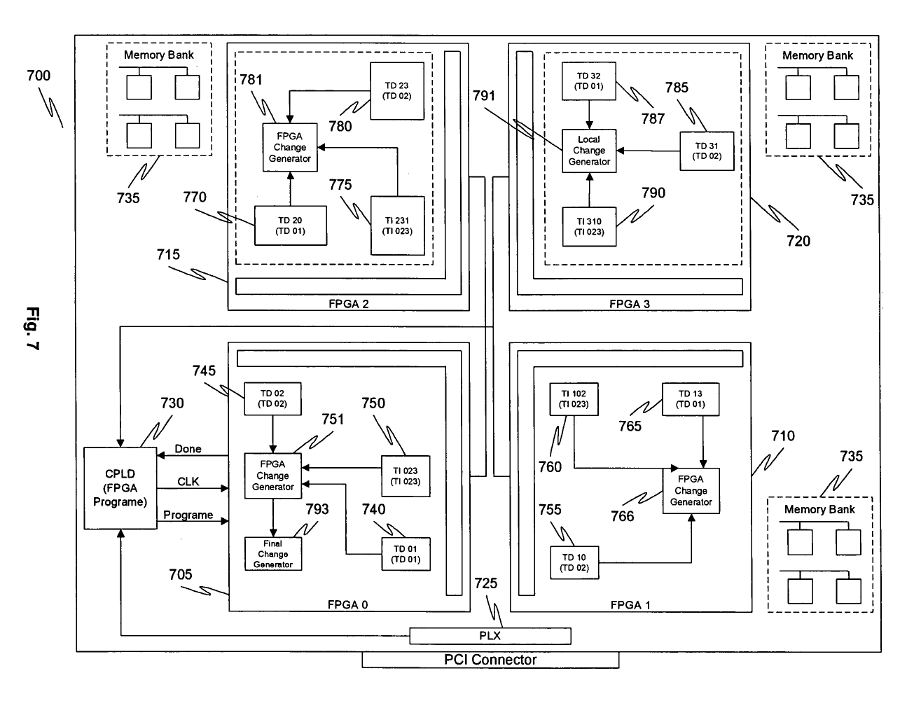

In another embodiment, FIG. 7 describes in details the emulation board 700 to test design. The board will sit on the PCI bus of a host computer. It uses a PCI interface chip which provides a high performance slave interface for PCI boards. The PCI interface chip is connected to the board controller through its local bus. The host computer passes on commands to the controller on the emulation board 700. The boards overall components comprises of four FPGAs 705, 710, 715 and 720, one PCI interface chip 725, a CPLD 730 and one or more memory banks 735.

The PCI bus interface will double the bandwidth into the board and can potentially speed up the emulation rate by 2×. The emulation board 700, uses the data bus for communication between the host and the controller. The address bits of the PCI bus pass on commands and data. The CPLD 730 sits on the local bus to take care of the local bus protocol before the FPGAs are fully configured. After configuration, the board controller starts communicating with the PCI chip over the local bus provided by the PCI Interface Controller. An application running on the host gives the controller commands by writing into some registers that the PCI Interface provides for this purpose.

In this way, the application on the host can command the board controller to perform activities. The major type of commands are providing inputs, initiating an emulating cycle, setting up addresses to monitor, start monitoring and reading inputs. The FPGA0 705 comprises of transmitter components TD01 740 for transmission from FPGA0 705 to FPGA1 710, TD02 745 for transmission from FPGA0 705 to FPGA2 715 and TD023 750 for transmission from FPGA0 705 to FPGA3 720 through FPGA2 715. Finally after the transmission, TD01, TD02 and TD 023 inform the FPGA change generator 751.

The FPGA1 710 comprises of transmitter components TD10 755 for transmitting from FPGA1 710 to FPGA0 705, TD102 760 for transmitting from FPGA1 710 to FPGA2 715 through FPGA0 705. Finally after the transmission, TD10, TD102 and TD13 inform the FPGA change generator 766.

The FPGA2 715 comprises of transmitter components TD20 770 for transmitting from FPGA2 715 to FPGA0 705, TD231 775 for transmitting from FPGA2 715 to FPGA1 710 through FPGA0 705 and TD 23 for transmitting from FPGA2 715 to FPGA3 720. Finally after the transmission, TD20, TD231 and TD 23 inform the FPGA change generator 781.

The FPGA3 720 comprises of transmitter components TD31 785 for transmitting from FPGA3 720 to FPGA1 710, TD 32 for transmitting from FPGA3 720 to FPGA2 715. TD310 790 for transmitting from FPGA3 720 to FPGA0 705 through FPGA1 710. Finally after the transmission, TD20, TD231 and TD 23 inform the FPGA change generator 791.

The final change generator 793 on FPGA0 705, collects all the FPGA change generator signals from 751, 766, 781 and 791.

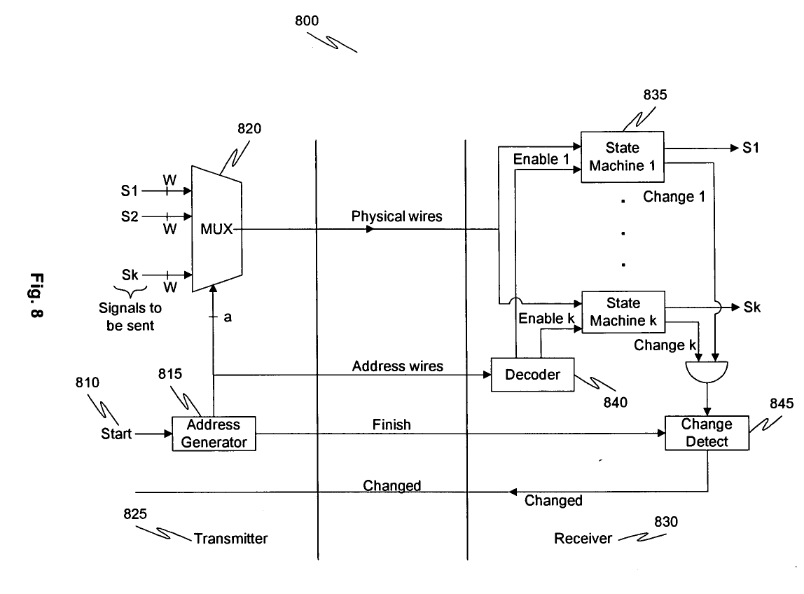

FIG. 8 depicts the inter-FPGA communication logic along with the change detect mechanism. In a typical transmitting circuit on a FPGA, the start signal 810 given to the address generator 815 controls the multiplexor 820. The multiplexer 820 multiplexes the signals to be sent out from the transmitting FPGA called the transmitter 825 to the receiving FPGA 830 through the physical wires between them. At the receiving FPGA called the receiver 830, the incoming input signal is given to all the state recorders also called state machines 835. The controlling address signal coming from the address generator 815 of the transmitter 825 is given to the decoder 840 at the receiver 830. The decoder 840 in turn controls the state machines 835 and allows the signal to pass through any one of the state machines and in turn the state machine records the change of state. The change of state from all such state machines 835 of a receiving FPGA 830 are clubbed and once all the state machines' values have changed a common change detect is transmitted back by the receiving FPGA 830 to the transmitting FPGA 825. At the receiver 830, address is used to latch signal and detect change 845. At finish, “changed” indicates a change in value of one of the received signals.

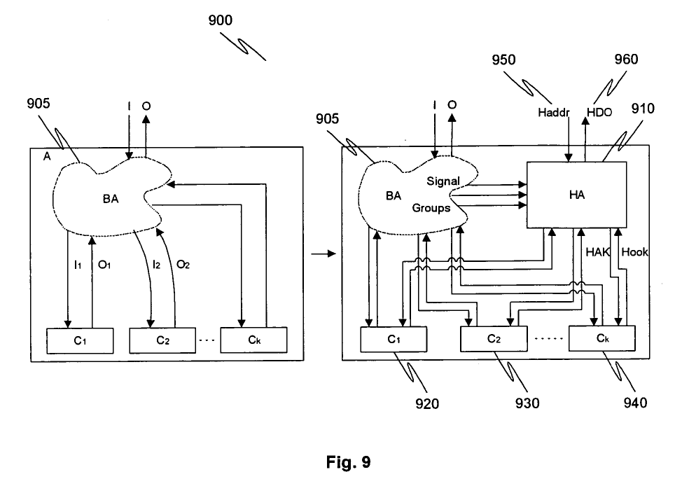

Another embodiment of the present invention is depicted in FIG. 9. FIG. 9 shows one embodiment of monitoring module where the HOOKIN component is used to observe the behavior of the design for entity A (BA) 905. The HA 910 is connected to observe behavior in A (BA 905). A has children namely C1 920, C2 930 to CK 940, where all children as well as A interacts with HA 910. Each child has a pair of input and output wires connecting it to BA 905. HA 910 connect to each of the children 920, 930 and 940 as well as to BA 905. The address bus (Haddr) 950 and data bus (Hdo) 960 connected to HA such as to assist the external signal visibility.

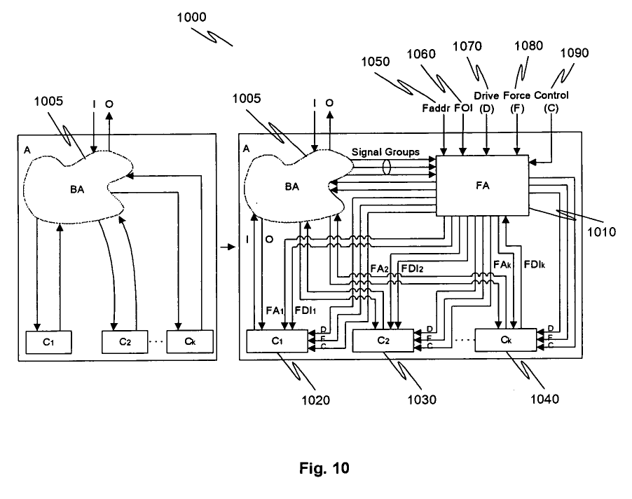

As depicted in FIG. 10, the FORCEIT component is for monitoring a signal (Struck to 0 or 1) and monitoring the clock cycle until circuit stabilization. The behavior of the component A (BA) 1005 along with its children C1 to CK is observed. Each child has a pair of input and output wires connecting it to FA 1010. FA 1010 connects to each of the children as well as to BA 1005. The address bus (Faddr) 1050, data bus (Fdo) 1060, Force (F) 1080 and the control (C) 1090 are connected to FA 1010 which would assist the external signal visibility by forcing the value to a fixed predetermined level.

The above description of the system and methods are meant to be illustrative and not restrictive. The present invention may be applied to emulate any design or algorithm. One skilled in the art will appreciate that although specific embodiments of the emulation system and methods have been described for purposes of illustration, various modifications can be made without deviating from the spirit and scope of the present invention. Accordingly, the invention is described by the appended claims.

What is claimed is:

1. A method for partitioning a logic circuit design, the method comprising the steps of:
recoding the logic circuit design;
assigning a first weight to each of one or more components to give a list of first weights, wherein each of the components comprises a memory component and a logic component;
assigning a second weight to each of one or more ports, the ports interconnecting the components, wherein the second weight is equal to a number of wires, wherein the wires interconnect the components;
generating a tree structure using the list of first weights; and
partitioning the tree structure using a tree-partitioning algorithm into a plurality of independent logic circuit designs, such that an original connectivity of each of the components is maintained.

2. The method of claim 1, wherein the recoding step further comprises replacing a plurality of bi-directional ports connecting a plurality of the components in the logic circuit design with a plurality of unidirectional ports.

3. The method of claim 1, wherein the assigning step further comprises
using a lookup table usage of the components.

4. The method of claim 1, wherein the generating step further comprises determining from the list of first weights a highest weight; and
assigning the highest weight to a root node.

5. The method of claim 4, wherein the generating step further comprises
arranging each of the components as a child node of the root node.

6. The method of claim 5, wherein the arranging step further comprises
maintaining the original connectivity between the root node and the child node according to the logic circuit design.

7. The method of claim 6 wherein the maintaining step further comprises
connecting the root node and the child node using the plurality of unidirectional ports.

8. The method of claim 1, wherein the partitioning step further comprises
maintaining a comparable weight for each of the independent logic circuit designs.

9. The method of claim 8, wherein the maintaining step further comprises
identifying a combined weight of each of the independent logic circuit designs as a sum of the first weight and the second weight of the components and the ports included in the independent logic circuit designs.

10. A method for emulating a logic circuit design using a plurality of programmable logic devices, the method comprising the steps of:
partitioning the logic circuit design into a plurality of independent logic circuit designs;
performing a memory transformation on a plurality of components of the independent logic circuit designs wherein each of the plurality of components comprises of a memory component and a logic component; whereby the plurality of components are one of the plurality of programmable logic devices;
performing a monitoring transformation on the independent logic circuit designs to monitor a plurality of internal signals sent and received by the logic components; and
interconnecting the independent logic circuit designs using a time phase schedule for communication maintaining an original functionality of the logic circuit design.

11. The method of claim 10 wherein the partitioning step comprises recoding the logic circuit design to replace a plurality of bi-directional ports connecting the plurality of components with a plurality of unidirectional ports.

12. The method of claim 10 wherein the partitioning step further comprises generating a tree structure of the logic circuit design.

13. The method of claim 10 wherein the generating step comprises assigning a first weight to the components using a lookup table usage of the plurality of logic components to give a list of first weights.

14. The method of claim 10 wherein the generating step further comprises of assigning a second weight to a plurality of ports, the plurality of ports connecting the components.

15. The method of claim 10 wherein the generating step further comprises
determining a highest weight from the list of first weights; and
making the highest weight a root node of the tree structure.

16. The method of claim 10, wherein the generating step further comprises
arranging each of the components as a child node of the root node.

17. The method of claim 16, wherein the arranging step further comprises
maintaining an original connectivity between the root node and the child node according to the logic circuit design.

18. The method of claim 17 wherein the maintaining step further comprises
connecting the root node and the child node using the plurality of unidirectional ports.

19. The method of claim 10 wherein the partitioning step further comprises using a tree-partitioning algorithm.

20. The method of claim 10, wherein the partitioning step further comprises
maintaining a comparable weight for each of the independent logic circuit designs.

21. The method of claim 20, wherein the maintaining step further comprises
identifying a combined weight of each of the independent logic circuit designs as a sum of the first weight and the second weight of the components and the ports included in the independent logic circuit designs.

22. The method of claim 10 wherein the memory transformation step further comprises extracting the memory component from the component of the independent logic circuit design and mapping the memory component onto a local memory controller, the local memory controller pertaining to a group of the components of the independent logic circuit design.

23. The method of claim 22 wherein the extracting step further comprises controlling the local memory controller onto a memory bank controller, the memory bank controller pertaining to at least one of the independent logic circuit design.

24. The method of claim 10 wherein the monitoring step further comprises adding an extra hardware in at least one of the independent logic circuit design while maintaining the original functionality; and
routing the plurality of internal signals,
whereby providing a complete random-access signal visibility of the logic components.

25. The method of claim 24, wherein the implementing step further comprises forcing the internal signal to a particular logic level value and observing the effect of the internal signal on a plurality of secondary signals corresponding to the internal signal.

26. The method of claim 10 wherein the interconnecting step further comprises connecting each of the independent logic circuit designs with a plurality of signal-communicating paths.

27. The method of claim 26 wherein the connecting step further comprises communicating the internal signals between the independent logic circuit design using a time phase schedule.

28. The method of claim 27 wherein the communicating step further comprises using a signal multiplexing process and a signal demultiplexing process over the signal-communicating path across the time phase schedule for communication.

29. The method of claim 27 wherein the communicating step further comprises clustering a distance on the signal-communicating path with the internal signals.

30. The method of claim 29 wherein the clustering step further comprises calculating the distance on the signal communicating path; whereby the distance is equal to a number of similar elements on the signal-communicating path.

31. The method of claim 30 wherein the calculating step further comprises identifying the number of similar elements as a number of a common source independent logic circuit design and a common destination independent logic circuit design.

32. A method of communicating between a plurality of independent logic circuit designs, the method comprising:
connecting at least two of the independent logic circuit design with a plurality of signal-communicating paths;
communicating a plurality of signals between the independent logic circuit designs in a plurality of time phase schedules; and
sending the plurality of signals through the signal-communicating path in the plurality of time phase schedules.

33. The method of claim 32 wherein the communicating step further comprises
executing a multiplexing process on the plurality of signals over the signal-communicating paths across the plurality of time phase schedules.

34. The method of claim 32, wherein the communicating step further comprises
executing a demultiplexing process on the plurality of signals over the signal-communicating paths across the plurality of time phase schedules.

35. The method of claim 32, wherein the communicating step further comprises clustering a distance on the signal communicating path, wherein the distance is equal to a number of similar elements on the signal communicating path.

36. The method of claim 35, wherein the communicating step further comprises identifying the number of similar elements as a number of a common source independent logic circuit design and a common destination independent logic circuit design.

37. A system for partitioning a logic circuit design, comprising:
a recoding module for recoding an input logic circuit design into a recoded design for implementing a tree generation algorithm,
a recoding module wherein the recoding module assigns a first weight to each component and assigns a second weight to each port of the logic circuit design;
a tree generation module for generating a tree structure from the recoded design using a list of weights; and
a partitioning module for partitioning the tree structure preserving the logic circuit design.

38. The system of claim 37, wherein the recoded design comprises a plurality of unidirectional ports.

39. The system of claim 37, wherein the tree structure maintains a comparable weight for each of the independent logic circuit designs.

40. The system of claim 37, wherein the partition module optimizes the recoded logic design such that the recoded design can fit into a plurality of programmable logic devices.

41. The system of claim 40 wherein the programmable logic devices comprises a field programmable gate array.

42. A system for emulating a logic circuit design using a plurality of programmable logic devices, the system comprising:
a partitioning module for partitioning the logic circuit design into a plurality of independent logic circuit designs;
a memory extractor and mapper module for performing memory transformations by extracting a plurality of components of the independent logic circuit design wherein each of the plurality of components comprises of a memory component and a logic component, and mapping the memory component onto an external system memory;
a monitoring module for observing the visibility of an internal signal buried in the logic circuit design, on the plurality of programmable logic device; and
a time division multiplexing module for scheduling the plurality of nets.

43. The system of claim 42, wherein the memory extractor and mapper module extracts the memory component from the logic circuit design and maps the memory component onto a local memory controller, the local memory controller pertaining to a group of the components of the independent logic circuit design.

44. The system of claim 42, wherein the monitoring module adds a second logic in at least one of the independent logic circuit while maintaining the original design, routing the plurality of internal signals on the programmable logic devices,
whereby providing a complete random-access signal visibility of the logic components.

45. The system of claim 44, wherein the monitoring module comprises forcing the internal signal to a particular logic level value and observing the effect of the internal signal on a plurality of secondary signals corresponding to the internal signal,
whereby providing greater controllability of the internal signals.

46. The system of claim 42, wherein the interconnections between the logic circuit design signals use a plurality of communication paths in a time phased scheduled mode.

47. The system of claim 46, wherein the communication paths uses a signal multiplexor at the transmitter and a signal decoder at the receiver.

48. The system of claim 47, wherein the multiplexor at the transmitter is initiated by the start signal given to the address generator logic, the address generator logic acts as a gate for the multiplexor to transmit.

49. The system of claim 47, wherein the decoder at the receiver is initiated by the address generator present at the transmitter, the decoder and the state recorder machine enables the plurality of signal states to be observed and recorded.

50. The system of claim 47, wherein the gates detects the change of state of the signal, a plurality of these changed signal states are then ANDed to give a common change detect out from the receiver to communicate that the change of signal state to the transmitter.

51. An application for emulating an input logic circuit design to an output logic circuit design suitable for execution on hardware, the application comprising:
a computing system including a long term memory, a processor readable memory and a processor, in communication with one another, the long term memory including a recoding module, the recoding module in communication with a processor and the processor readable memory, and when the user runs the application: (a) the recoding module replaces a plurality of bi-directional ports connecting a plurality of the components in the logic circuit design with a plurality of unidirectional ports; (b) the partitioning module for partitioning the logic circuit design into a plurality of independent logic circuit designs; (c) the memory extractor and mapper module for performing memory transformations by extracting a plurality of components of the independent logic circuit design wherein each of the plurality of components comprises of a memory component and a logic component, and mapping the memory component onto an external system memory; (d) the monitoring module for observing the visibility of internal signal buried in the logic circuit design, on the plurality of programmable logic device; and (e) the time division multiplexing module for scheduling the nets;
wherein the recoded design is stored in a media and the recoded design is further transformed and transferred to a processor readable memory of a system including the processor readable memory and the processor when the media is used with the system.
